(19) United States
(12) Patent Application Publication
(10) Pub. No.: US 2019/0170560 A1
(43) Pub. Date: Jun. 6, 2019

(54) ALERT SYSTEM FOR DETECTING CONTENTS WITHIN A CONTAINER

(71) Applicant: First Sales, LLC, Churubusco, IN (US)

(72) Inventors: Robert D. Rohr, Huntertown, IN (US); Rudy B. Wilfong, Fort Wayne, IN (US); Adam Michael Brososky, Fort Wayne, IN (US)

(73) Assignee: First Sales, LLC, Churubusco, IN (US)

(21) Appl. No.: 16/205,992

(22) Filed: Nov. 30, 2018

Related U.S. Application Data
(60) Provisional application No. 62/594,702, filed on Dec. 5, 2017.

(51) Int. Cl. G01F 23/296; G01F 23/292

(52) U.S. Cl. CPC G01F 23/2962; G01F 23/292

(57) ABSTRACT

A media level alert is useable in the context of a fluid additive system, such as a water softener. The alert system includes a sensor that does not directly interface with media within a container, such that the sensor can measure the media level without being exposed to contact with the media itself. Further, the alert system may utilize a “time of flight” sensor that emits a signal and, based on a measurement of the time it takes for the signal to be reflected off the media and returned to the sensor, facilitates a calculation of the distance from the sensor the media. When the distance reaches a predetermined threshold associated with a low-media condition within a media storage container, a controller may initiate a refilling protocol.

### CROSS REFERENCE TO RELATED APPLICATION

This application claims the benefit under Title 35, U.S.C. § 119(e) of U.S. Provisional Patent Application Ser. No. 62/594,702, entitled ALERT SYSTEM FOR DETECTING CONTENTS WITHIN A CONTAINER and filed on Dec. 5, 2017, the entire disclosure of which is hereby expressly incorporated by reference herein.

### BACKGROUND

### 1. Technical Field

The present disclosure relates to an alert system and, more particularly, to an alert system for detection of contents within a container suitable for water treatment equipment, such as ion exchange water softeners and media filters.

### 2. Description of the Related Art

Fluid control valves are generally used for water treatment systems, such as water softeners that remove certain minerals from the water and then deliver the treated water to the end user. Such minerals (e.g., calcium, magnesium, manganese and iron) contribute to what is commonly referred to as water “hardness.” Water softener systems may employ an ion exchange process to bond the minerals to other materials. Such ion exchange may be effected by providing an ion exchange resin bed containing resin materials designed to promote the ion exchange process. The resin bed is housed in a resin tank which is filled with some of the water from the water source. As this water passes across the resin bed, ions of calcium and other positively charged ions are exchanged with ions held by the resin (typically sodium). Objectionable hardness minerals are thereby removed from the water and replaced with less objectionable ions from the resin.

Ion exchange resin capacity is gradually depleted as the ion exchange process is repeated over time. Water treatment controls may be provided as part of a water softener system to periodically regenerate the resin contained in the resin tank. This regeneration can be accomplished, for example, by the reversal of the above-described softening process. That is, the objectionable ions formerly bonded to the resin during the water softening process (such as calcium) are chemically replaced with less objectionable sodium or similar ions. In some systems, this reversal is accomplished by passing a regenerant solution of sodium or potassium chloride through the resin bed.

To effect distribution of the regenerant solution, a control valve may be attached to the top of the resin tank. The control valve includes a structure for directing the flow of fluid to complete the regeneration process, such as a reciprocating piston, rotating disc or poppets. The regeneration process controlled by the control valve may include a number of steps, such as: i) a backwash cycle to remove turbidity from the resin bed; ii) a brine draw cycle to introduce the regenerant to the resin bed; iii) a rinse to eliminate chlorides in the finished water; and iv) a brine refill cycle to prepare a brine solution for the next regeneration. During the time elapse during these various cycles, the control valve may also provide an internal bypass to provide untreated water to the end user, so that water supply remains uninterrupted.

In addition to the application of a water softener as described above, a fluid control valve can be used on various water filters. Control valves used on water filter systems may, for example, be used to effect a backwash cycle to remove collected precipitated iron, or sediment from filter elements, or to replenish an oxidizer reservoir within the filter system with material for oxidation (e.g., potassium permanganate, chlorine or air).

As the system operates, the resin or other media is consumed. Typically, such media is located in a media storage tank with a user-accessible interior cavity, such that the user can periodically refill the storage tank with new media as the level drops.

### SUMMARY

The present disclosure provides a media level alert useable in the context of a fluid additive system, such as a water softener. The alert system includes a sensor that does not directly interface with media within a container, such that the sensor can measure the media level without being exposed to contact with the media itself. Further, the alert system may utilize a “time of flight” sensor that emits a signal and, based on a measurement of the time it takes for the signal to be reflected off the media and returned to the sensor, facilitates a calculation of the distance from the sensor the media. When the distance reaches a predetermined threshold associated with a low-media condition within a media storage container, a controller may initiate a refilling protocol.

In one form thereof, the present disclosure provides an alert system comprising: a container sized and configured to receive a quantity of media; and a sensor coupled to the container and spaced away from the media, the sensor configured to detect the presence of an amount of media within the container, a controller programmed to compare the detected amount of media within the container to a threshold, and to take a corrective action when the amount of media is below the threshold.

In another form thereof, the present disclosure provides a low-media alert system, comprising: a water softener comprising a media container and a valve system configured to mix brine contained in the media container with a stream of incoming water; a time-of-flight sensor coupled to the media container at a location spaced away from the media, the time-of-flight sensor configured to measure a distance from the sensor to a media level within the media container; and a controller programmed to compare the measured distance to a threshold distance associated with a low-media condition within the container, and to take a corrective action when the measured distance is larger than a preprogrammed threshold distance.

In yet another form thereof, the present disclosure a method of providing a low-media alert for a water softener, the method comprising: activating a sensor attached to a media container, the sensor sized and configured to provide water softening media to the water softener; activating a controller to detect a level of the media in the container via the sensor; and initiating a refilling protocol when a level of media in the container falls below a predetermined threshold.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of alert system coupled to a media container of a water softener made in accordance with the present disclosure;

FIG. 2 is a cross sectional view of the system shown in FIG. 1, taken along the line 2-2;

FIG. 3 is a perspective view of the alert system shown in FIG. 1;

FIG. 4 is an exploded, perspective view of an alert of the alert system of FIG. 1 in accordance with the present disclosure;

FIG. 5 is a bottom exploded, perspective view of the alert of FIG. 4;

FIG. 6 is a perspective view of a sensor used in the alert system of FIG. 1 in accordance with the present disclosure; and

FIG. 7 is a flowchart illustrating the interaction of the sensor of FIG. 6 within the alert system of FIG. 1.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION OF THE PRESENT INVENTION

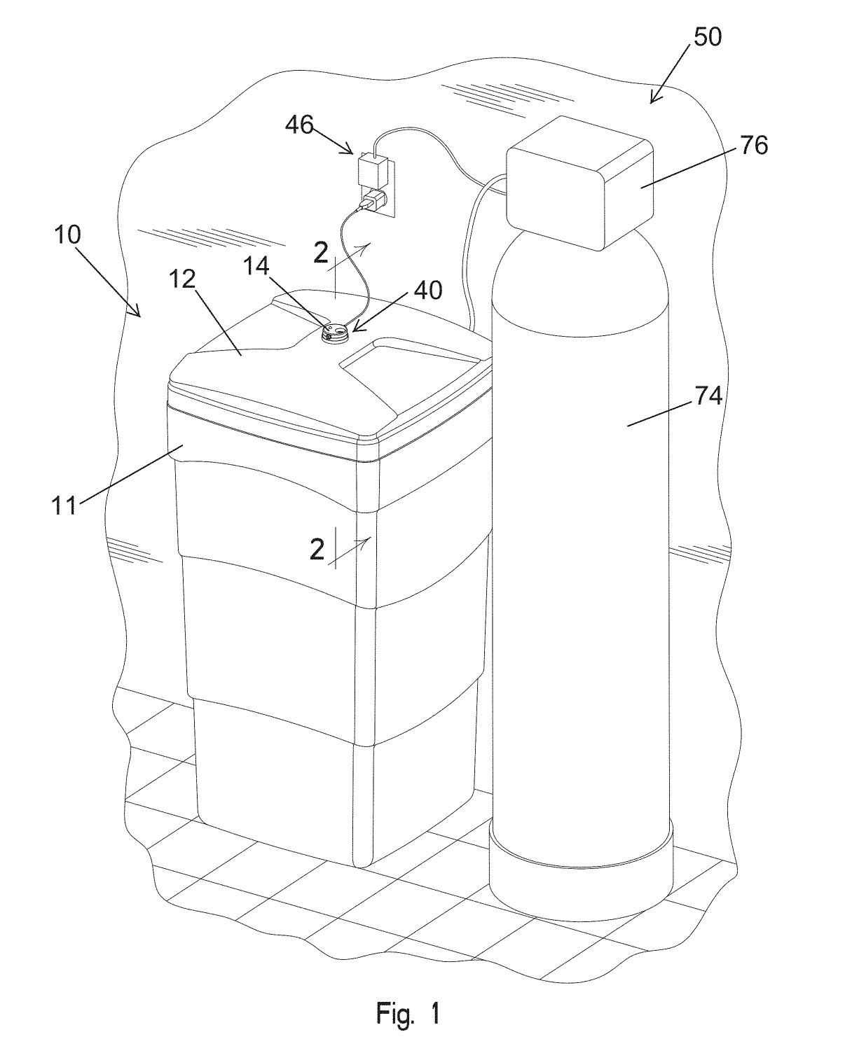

The following embodiments of the present invention are chosen and described so that others skilled in the art may utilize their teachings. The present disclosure is directed to an alert system 40 and other associated structures for a fluid treatment system, such as a water softener system 50 shown in FIG. 1. However, it will be understood that the system may have applications to other scenarios and in other contexts, such as other types of storage containers.

Turning to FIG. 1, water softener 50 includes mineral tank 74, media storage vessel 10 (commonly referred to as a brine tank) and a valve head 76 interconnecting tanks 74, receiving incoming flow, and discharging outgoing flow. Storage vessel 10 has a container 11, a lid 12 coupled to container 11, and an alert system 40 coupled to lid 12. In particular, alert system 40 includes sensor assembly 14 coupled to lid 12 and electrically coupled to an electrical outlet 46 as further described herein.

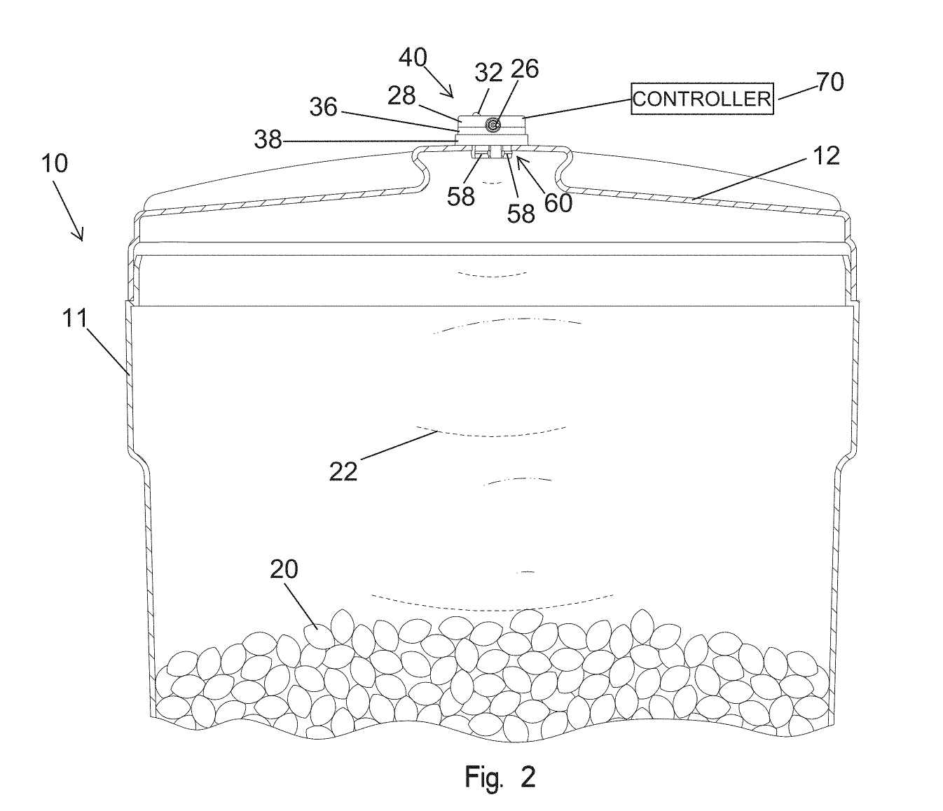

As shown in FIG. 2, sensor assembly 14 is positioned and configured to detect the amount of media 20 present in container 11 and, when the amount of media 20 is below a threshold level, issue a signal or an alert. Sensor assembly 14 may, for example, provide the signal or alert to a user via a visual and/or audible alert as discussed below. Moreover, sensor assembly 14 performs these detection and signaling functions without the need for direct exposure (e.g., contact) to media 20. In the illustrative embodiment of FIG. 2, for example, sensor assembly 14 is coupled to lid 12 and thereby spaced apart from media 20 in container 11, which is always below lid 12.

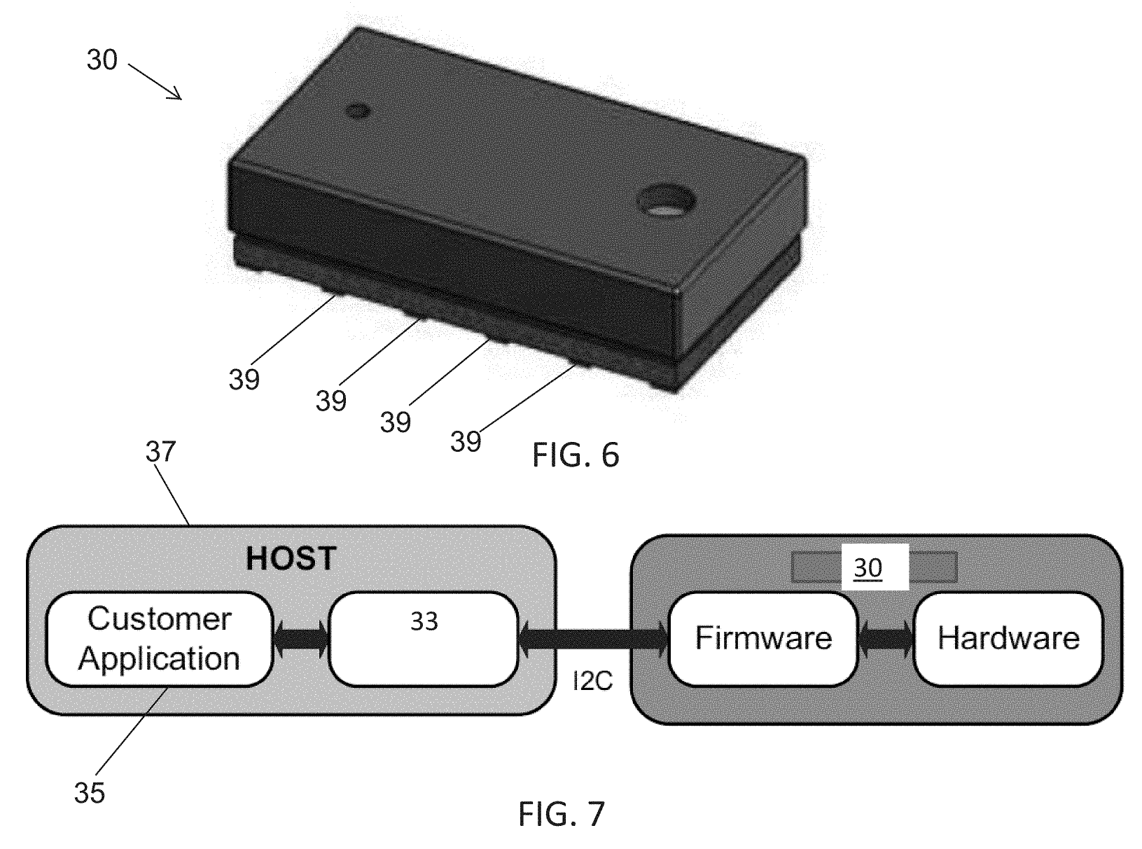

In an exemplary embodiment, sensor assembly 14 utilizes waves 22 (FIG. 2) to detect the amount of media 20 present in container 11. Sensor assembly 14 includes a combination sensor and emitter 30, as shown in FIG. 6, disposed on the lower surface of circuit panel 34 an facing downwardly into the interior of container 11 from its mounting point upon lid 12 (FIG. 2) Sensor/emitter 30 emits a wave 22 from a (FIG. 6) downwardly toward the bottom of container 11, where media 20 is located. In one embodiment, wave 22 is a sound wave. However it is contemplated that in alternate embodiments, alternate waves may be utilized, such as light waves, electromagnetic waves, microwaves, or laser waves for example. In one embodiment, sensor/emitter 30 of sensor assembly 14 is capable of both emitting waves 22 having, e.g., a wavelength of 940 nanometers, and sensing the return of the emitted waves 22 after such waves are reflected by nearby surfaces.

Upon emitting wave 22, a timer (which may be part of controller 70 shown in FIG. 2) measures the amount of time for the emitted wave 22 to return to sensor/emitter 30. Based on this “time of flight” of the wave and a known speed of the wave (e.g., the speed of sound where wave 22 is a sound wave), controller 70 calculates the distance from sensor/emitter 30 to media 20 and compared this distance to a known distance to the bottom of container 11. Controller 70 then calculates the difference between the known distance and the measured distance to produce the vertical extent, and therefore the amount, of media 20 present at the bottom of container 11.

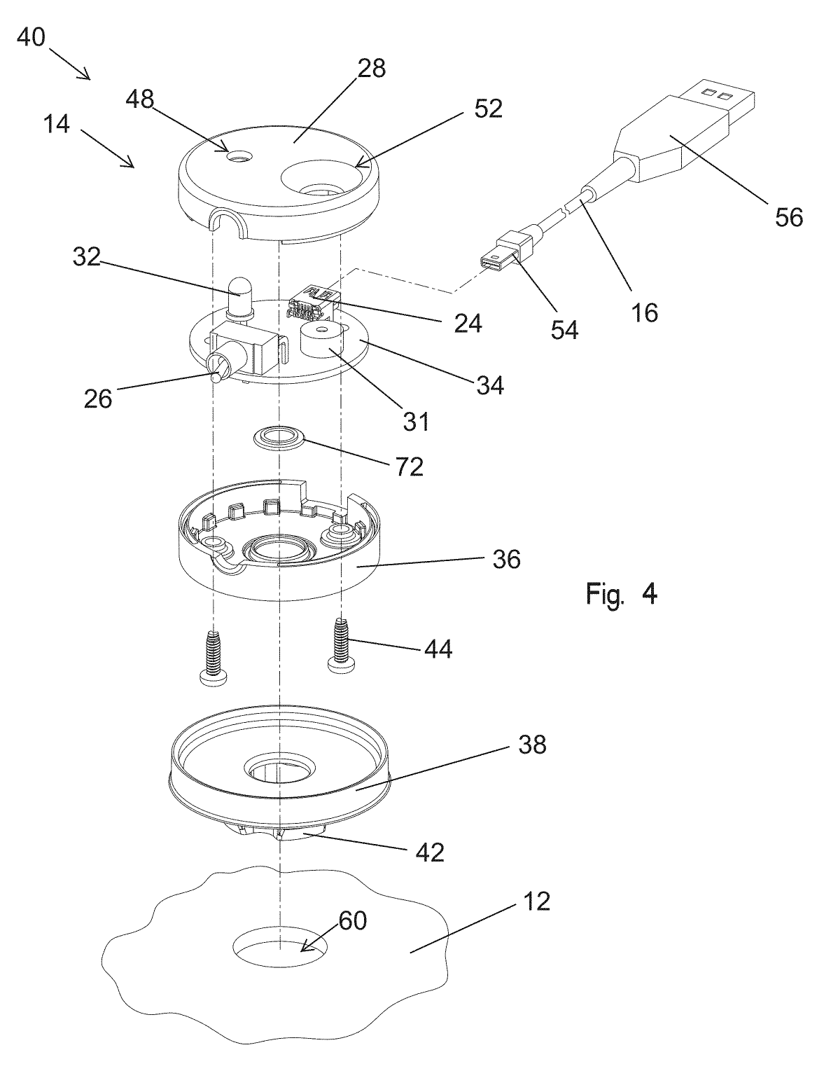

If the measured amount of media 20 is less than the predetermined threshold, controller 70 may initiate a refilling protocol by, e.g., activating indicator light 32 and/or sound emitter 31 (FIG. 4), and thereby alerting a user of the amount of media within container 11. The refilling protocol may include other corrective actions, such as other types of notifications including email or SMS text message notifications, or initiation of an automatic refill procedure, for example. Conversely, if the measured amount of media 20 is greater than the predetermined threshold stored in sensor assembly 14, indicator light 32 and sound emitter 31 remains in their default off states. In one embodiment, indicator light 32 is an LED light and sound emitter 31 is a speaker. As an alternative to an on/off indicator light 32, controller 70 (FIG. 2) may communicate with light 32 to provide an indication of the level of media 20 and light 32 may have multiple illumination modes to indicated different levels. For example, a green light may be illuminated by controller 70 when the level of media 20 is considered adequate, a yellow light may be illuminated by controller 70 when the level of media 20 is considered “low but not depleted,” and a red light may be illuminated by controller 70 when the level of media 20 is considered “depleted.”

This calculated amount of media 20 may then be compared by controller 70 to a predetermined media threshold programmed in controller 70. The predetermined threshold may be user-modifiable and/or may be set upon initial controller programming. In the context of water softener system 50, the predetermined threshold may be set to correspond with a remaining water treatment capacity of at least 100 gallons, 200 gallons, or 300 gallons, for example, or to any water treatment capacity deemed sufficient to allow continuous and uninterrupted treatment of water while also providing adequate time for a user of the system to notice a low-media alert and take corrective action (i.e., filling or causing the filling of container 11).

In an exemplary embodiment, sensor assembly 14 emits waves 22 periodically based on a predetermined schedule such that sensor assembly 14 operates automatically without any need for active user input and interaction. This provides substantially “real-time” feedback to a user regarding the levels of media present in container 11. Sensor assembly 14 may also emit waves 22 upon a user command or input. Alternatively or in addition to this alerting function, controller may provide a display (not shown) of the calculated media level, such as a gauge that a user can monitor to assess the media level between a “full” and “empty” level.

In some embodiments, controller 70 may initiate an automated replenishment protocol in response to the level of media 20 falling below the predetermined threshold. For example, controller 70 may open a valve to an auxiliary media storage container (not shown), thereby allowing media 20 to flow into container 11 until an upper limit is reached within container 11, as measured by sensor/emitter 30. When such upper limit is reached, container 11 may be deemed “full” and the valve may be closed.

In an exemplary embodiment, sensor/emitter 30 is a time-of-flight ranging device with controller 70 integrated therein as an embedded micro-controller. Sensor/emitter 30 may vary in size, and in one embodiment, sensor/emitter 30 has dimensions of 4.4 mm×2.4 mm×1.0 mm to facilitate integration into any size lid 12 which may be included as part of a previously-installed, existing water softener 50. An exemplary sensor/emitter 30 suitable for use in sensor assembly 14 is further described in Appendix A attached hereto, the entire disclosure of which is hereby expressly incorporated herein by reference. In another embodiment, controller 70 may be integrated into valve head 76, which may also include other control functions for water softener 50.

Turning to FIG. 6, sensor/emitter 30 includes a plurality of pins 39 to couple sensor/emitter 30 to other parts of sensor assembly 14 such as a digital input/output, a power supply, etc. In general, pins 39 are respectively connected to a power supply (e.g., via electrical outlet 46) and a host 37. FIG. 7 shows a functional description of sensor/emitter 30 and its interaction with host 37. Host 37 includes a customer application 35 and an Application Programming Interface (API) 33. Customer application 35 of host 37 controls sensor/emitter 30 using the Application Programming Interface (API) 33. API 33 allows the user to take full benefit of the capabilities of sensor/emitter 30. API 33 exposes a set of high level functions to customer application 35 and allows control of the firmware of sensor/emitter 30 such as initialization/calibration, ranging start/stop, choice of accuracy, and choice of ranging mode. In some embodiments, host 37 and its functions may be integrated into controller 70 (FIG. 2).

Additionally, sensor/emitter 30 includes a plurality of modes in which it can operate. For example, sensor/emitter 30 may have a continuous, timed mode where sensor/emitter 30 is continuously active and emits waves 22 periodically with a standard time interval between each emission of wave 22 and measurement of time of flight until the reflected wave is detected. In a further exemplary embodiment, sensor/emitter 30 includes a continuous mode where sensor/emitter 30 continuously emits waves 22 to measures the level of media 20 within container 11 in real-time. In a further exemplary embodiment, sensor/emitter 30 includes a single mode where sensor/emitter 30 emits wave 22 when prompted by the user. After emitting wave 22 and measuring the contents of container 11, sensor/emitter 30 returns to a stand-by mode awaiting instruction from the user to emit a subsequent wave 22. It is contemplated that further suitable modes having various time intervals and wave emission patterns may be applied to sensor/emitter 30.

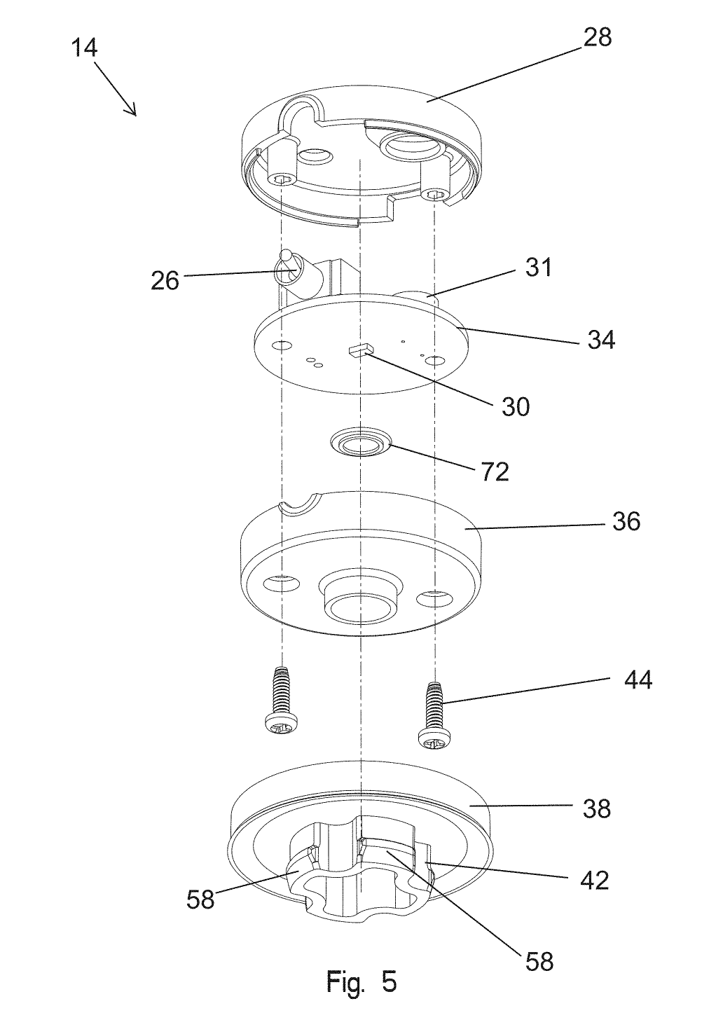

An exemplary embodiment of sensor assembly 14 are shown in detail in FIGS. 4 and 5, together with additional components of alert system 40. Sensor assembly 14 includes sensor assembly lid 28 received on sensor assembly base 36, with a circuit panel 34 positioned between the lid 28 and the base 36. Panel 34 includes a number of electrical components forming a part of sensor assembly 14, as described further below. Lid 28, circuit panel 34, and base 36 are coupled together by fasteners such as screws 44. Lid 28 includes apertures 48, 52 that are sized and positioned to receive indicator light 32 and sound emitter 31, respectively.

Switch 26 operates to toggle sensor assembly 14 between sound-emitting and silenced configurations. In the sound-emitting configuration, both indicator light 32 and sound emitter 31 can be activated by controller 70 as described herein. In the silenced configuration, sound emitter 31 remains deactivated regardless of the state of controller 70, while indicator light 32 can be activated by controller 70 as described herein.

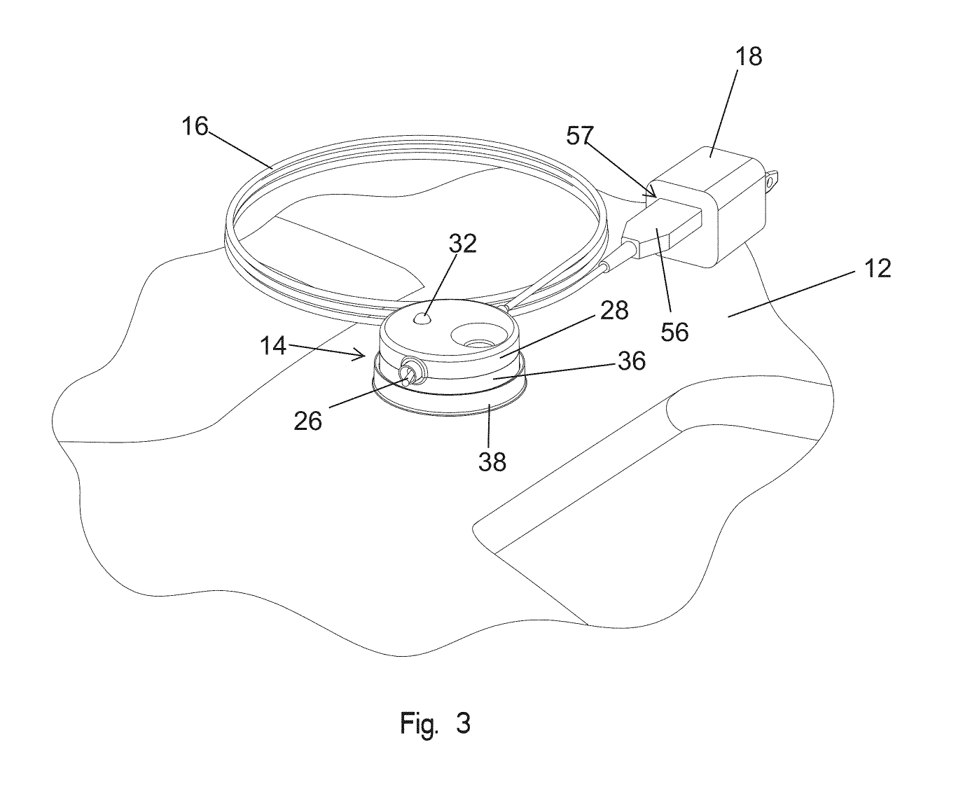

Cord receiving connector 24 is positioned on panel 34 and configured to receive power and/or data cord 16. As shown in FIGS. 3 and 4, cord 16 includes a male connector 54 configured to be received in the corresponding female cord receiving connector 24. In one embodiment, connector 54 includes a mini-USB connection with cord receiving connector 24. However, it is contemplated that in alternate embodiments, a USB, micro-USB, or other types of connections may be formed between connector 54 and cord receiving connector 24. Similarly, at the other end of cord 16, a second connector 56 is provided. Connector 56 is configured to electrically couple to a plug 18 (FIG. 3) to complete the electrical circuit and activate sensor assembly 14 when plug 18 is inserted into electrical outlet 46 (FIG. 1) and connector 54 is inserted into cord receiving connector 24. Alternatively, connector 56 may be electrically coupled to the power source for valve head 76, via a printed circuit board or other power converter contained within valve head 76. In one embodiment, connector 56 is a USB connector and plug 18 has a corresponding receiving port 57 for connector 56. The USB connector can also be plugged into a computer for programming, diagnostics, and other data transfer to and from controller 70 and the other components of sensor assembly 14.

Circuit panel 34 provides an upper surface (FIG. 4) upon which switch 26, indicator light 32, sound emitter 31, and cord receiving connector 24, switch 26 are mechanically supported and electrically coupled to one another. In addition, a lower surface (FIG. 5) of circuit panel 34 mechanically supports sensor/emitter 30, which may have controller 70 integrated therewithin, and allows these components to be electrically coupled to one another and to the components on the upper surface. Lens 72 may be interposed between sensor/emitter 30 and base 36 to protect sensor/emitter 30 from ambient contamination, such as any contamination from media 20 contained within container 11, while also allowing transmission of wave 22 therethrough. For example, lens 72 may be made from clear glass or clear plastic material in order to readily transmit wave 22 while also providing a physical barrier to ingress of contamination. In an exemplary embodiment, lens 72 creates a hermetically sealed environment for sensor/emitter 30 to ensure a long service life and reliable operation.

With lid 28, panel 34, and base 36 coupled to each other, the assembled package can then removably coupled to lid connector 38 via base 36. Lid connector 38 contains a cup-shaped upwardly facing interior which tightly receives base 36 of sensor assembly 14 such that sensor assembly 14 has a secure fit within lid connector 38, i.e., a user would need to apply a significant amount of force in order to remove sensor assembly 14 from lid connector 38. In one embodiment, lid connector 38 is made of rubber and is formed in a similar fashion to a rubber stopper, though it is contemplated that lid connector 38 may be made of other materials such as plastic, high density polyethylene (HDPE), etc.

Lid connector 38 includes a retention clip 42 extending downwardly from the cup-shaped portion that couples to base 36 of sensor assembly 14. Retention clip 42 serves to couple sensor assembly 14 to lid 12 of vessel 10. Retention clip 42 includes a plurality of flexible protrusions 58 that operate to resiliently fix sensor assembly 14 to lid 12. In particular, lid connector 38 may be press-fit into a hole formed in lid 12 (as shown in FIG. 4), such that protrusions 58 deform inwardly by engagement with the edge of aperture 60 (FIGS. 2 and 4). As protrusions 58 descend beyond the edge of aperture 60, protrusions 58 resiliently extend outwardly and return to their original configuration. While the lower portions of protrusions define a gently sloped surface designed to promote this deformation with minimal downward force upon installation, the upper portion of protrusions 58 define a sloped surface much closer to horizontal, which requires a substantially higher upward force upon removal. In this way, the configuration of protrusions 58 facilitates installation of lid connector 38 to lid 12 while also providing a secure fit for lid connector 38 within aperture 60 after installation.

In an alternative embodiment, sensor assembly 14 may be mounted at another location relative to container 11, and simply oriented and positioned to monitor the level of media 20 in the same or similar manner as the lid-mounted embodiment shown in FIGS. 1-3 and described herein. For example, container 11 may be an open-top barrel which does not include a lid, and sensor assembly 14 may be mounted to a fixed or movable arm which can be removed or pivoted out of the way for loading and/or removing media 20. Such open-top barrels may be used, for example, in connection with large-capacity media containers commonly associated with industrial applications.

In operation, when sensor assembly 14 and lid connector 38 are installed onto lid 12 or otherwise positioned and oriented to monitor the level of media 20, cord 16 is electrically coupled to cord receiving connector 24 and plug 18, and plug 18 is electrically coupled to electrical outlet 46 to power alert system 40 via electric power provided from electrical outlet 46. In an alternate embodiment, sensor assembly 14 may have a battery or a portable source of power such that cord 16 and plug 18 are not required.

Once electrically powered, sensor/emitter 30 emits wave(s) 22 within container 11 to measure the amount of media within container 11 in accordance with a predetermined schedule for sensor assembly 14, as described in detail above. Once wave 22 is emitted, sensor/emitter 30 measures the amount of time needed for wave 22 to return to sensor/emitter 30 and calculates the amount of media 20 within container 11 based on its time of flight measurement. Sensor/emitter 30 then compares the measured amount of media 20 with a predetermined threshold (which may be set by the user or pre-programmed). If the measured amount of media 20 within container 11 is less than the predetermined threshold, indicator light 32 and/or sound emitter 31 will be activated (depending on the positioning of switch 26), such that a user will be notified of the condition within container 11 an appropriate action may be taken by the user. In other embodiments, controller 70 may initiate another corrective action or remediation procedure, such as automatic refill of storage container 11 as described above.

The configuration of sensor assembly 14 provides for a retrofittable alert system 40 that can be inserted on to a multitude of different systems, whether pre-existing or newly installed. For example, alert system 40 may be installed to work with an existing, previously installed water softener (e.g., water softener 50 shown in FIG. 1), or in other water filtration systems where sensor assembly 14 can be configured to detect the amount of media present within a container, such as container 11 having media 20 (FIG. 2). In such uses, alert system 40 functions to monitor the amount of media present in the container and, when the media is below a predetermined threshold, to alert a user or take other corrective action.

For example, an exemplary application in which alert system 40 may be utilized is the water treatment system described in U.S. Patent Application Publication No. 2016/0252185 entitled “Fluid Additive Control Valve,” filed on Mar. 1, 2016, the entire disclosure of which is hereby explicitly incorporated by reference. Alert system 40 may be used to detect the level of media 20 stored within container 11, which is used by the system to “soften” or chemically alter incoming water. Alert system 40 may work with controller 70 to set alerts and/or activate system functions—e.g., brine regeneration, brine charge, water softening, backwash, and rinse cycles—by electronically controlling the movement of corresponding parts of the water softener system. For example, when an indication of “low but not depleted” for the level of media 20 is received by controller 70, controller 70 may reconfigure the function of the control valve to limit the rate of media depletion, such as by preventing a “full regeneration” cycle in favor of a partial regeneration in order to preserve the longevity of the remaining media. Controller 70 may also output a “low but not depleted” and/or “add salt” signal to alert the user to replenish media 20 soon. In addition, when an indication of “media depleted” for the level of media 20 is received by controller 70, controller 70 may shut down the function of the control valve to avoid any regeneration process from occurring, and/or output a “media depleted” and/or “add salt” signal to alert the user to replenish media 20 immediately.

Controller 70 may also include wireless communication functionality in order to transmit status signals pertaining to storage vessel 10 to a location remote from the immediate area around vessel 10. For example, controller 70 may be “WiFi” capable by including an integrated wireless signal generator which is designed to be compatible with a radio wireless local area network of devices based on the standards set forth in IEEE 802.11. The signal generator may output wireless signals as described herein, and such signals may be received by a wireless network interface controller (e.g., an internet router) for distribution to other devices. To the extent that vessel 10 may be located beyond the range of a preferred wireless network interface controller, controller 70 may include an antenna to extend the range of generated signals to reach more remote interface controllers.

In one embodiment, the wireless signals generated by controller 70 are uploaded to a website, which may be access by a user of alert system 40. The user may login to the website via an internet-connected computer terminal or phone, for example, to view the status and function of storage vessel 10 as monitored by alert system 40. Alternatively or in addition to website upload, controller 70 may send signals directly to a computer terminal or phone via email, SMS text message, or other communication protocol.

In addition to the function signals, level signals, and other signals as described herein, controller 70 may generate additional signals for particular use in the context of remote monitoring. For example, a specific service set identifier (SSID) may be assigned to and associated with a particular vessel 10, such as via manufacturer programming. This SSID may be output by controller 70, such that the user or manufacturer can identify via a remote terminal (computer, phone, etc.) the location and operational presence of a designated vessel 10. Controller 70 may also output a “heart beat” indicator which, when received by a remote terminal, indicates that alert system is connected, functioning and online.

Controller 70 may also be programmed to receive signals from a remote location via its wireless network interface controller, and use these signals to influence the operation and function of alert system 40 and vessel 10. For example, a manufacturer may modify the level signals thresholds associated with “full,” “low but not depleted” or “medial depleted” states for the level of media 20, in order to adjust the function of alerts for a particular installation. A user may be able to view, adjust and initiate media refill operations, regeneration cycles or any other system function as described herein. As with the receiving and view of signals generated by controller 70, signals may be sent to controller 70 by a computer terminal, phone or other remote device capable of communicating via the wireless network interface controller.

Furthermore, sensor assembly 14 may be used in combination with the regenerant substrate monitor of the aforementioned publication (U.S. Patent Application Publication No. 2016/0252185), which is incorporated by reference herein. Ion exchange water softeners may require regeneration periodically with salt brine. Sodium chloride or potassium chloride in pellet or rock form may be stored in a substrate reservoir, which may be a plastic or fiber glass vessel in some exemplary embodiments, of a water softener. Water is added to reservoir during one of the cycles provided by the ports of the valve arrangement cooperating with the piston as described in U.S. Patent Application Publication No. 2016/0252185. Each time the water softener regenerates, salt is consumed from the reservoir (such as container 11). The amount used during each regeneration cycle varies by the relative size of the water softener 30 and elective programming. Sensor assembly 14 may be used in a manner described above to alert the user when salt or substrate in the reservoir is low, thereby ensuring that such substrate will remain continuously available to the water softener by urging users to refill the reservoir when necessary. Alternatively, in some systems, sensor assembly 14 may initiate an automated replenishment protocol as noted above. This continuous availability of substrate, in turn, ensures proper regeneration of the brine and proper softening of the water passing through the valve arrangement. This properly softened water protects steam boilers and other water using equipment, and in other applications where water quality is of particular importance such as hospitals, laundries, car washes, window manufactures, nursing homes, pretreatment for reverse osmosis membranes, commercial dishwashers, etc.

While this invention has been described as having an exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An alert system comprising:
a container sized and configured to receive a quantity of media; and
a sensor coupled to the container and spaced away from the media, the sensor configured to detect the presence of an amount of media within the container,
a controller programmed to compare the detected amount of media within the container to a threshold, and to take a corrective action when the amount of media is below the threshold.

2. The alert system of claim 1, wherein:
the sensor comprises a sensor/emitter configured to emit a signal into the container, receive a reflection of the signal, and measure an amount of time between the emitting and the receiving of the signal; and
the sensor/emitter further configured to determine the amount of media within the container based on the amount of time and a known speed of the signal.

3. The alert system of claim 2, wherein the signal is a sound wave.

4. The alert system of claim 2, wherein the signal is a light wave.

5. The alert system of claim 1, wherein the sensor is fitted to a lid of the container.

6. The alert system of claim 1, further comprising a sensor assembly comprising:
the sensor; and
an indicator signal operably coupled to the sensor and operable to selectively provide an alert to a user, wherein the corrective action is an activation of the indicator signal.

7. The alert system of claim 6, further comprising a switch configured to toggle the indicator signal of the alert between a first signal configuration in which the indicator signal is both an audible signal and a visual signal, and a second signal configuration in which the indicator signal is the visual signal without the audible signal.

8. The alert system of claim 6, wherein the sensor assembly further comprises:
a base;
a lid coupled to the base;
a circuit panel positioned between the base and the lid, the indicator signal and the sensor supported by and electrically connected via the circuit panel; and
the alert system further comprising a connector coupled to the base of the sensor assembly, the connector having a retention clip configured to couple the connector and the sensor assembly to the container.

9. The alert system of claim 8, further comprising a lens interposed between the sensor and the base, the lens operable to protect the sensor from contamination with material from the container.

10. The alert system of claim 8, wherein the retention clip of the connector includes a plurality of flexible protrusions operable to resiliently fix the connector and the sensor assembly to the lid of the container.

11. The alert system of claim 10, wherein each protrusion of the retention clip includes:
a lower portion defining a gently sloped surface designed to deform with minimal downward force upon installation to the lid; and
an upper portion defining a sloped surface closer to horizontal, such that the upper portion is designed to requires a substantially higher upward force for removal from the lid.

12. The alert system of claim 6, wherein the sensor assembly further comprises a port configured to electrically couple the sensor to an electrical power source.

13. The alert system of claim 1, in combination with a quantity of media contained within the container, the quantity of media comprising a substrate for a water softener.

14. A low-media alert system, comprising:
a water softener comprising a media container and a valve system configured to mix brine contained in the media container with a stream of incoming water;
a time-of-flight sensor coupled to the media container at a location spaced away from the media, the time-of-flight sensor configured to measure a distance from the sensor to a media level within the media container; and
a controller programmed to compare the measured distance to a threshold distance associated with a low-media condition within the container, and to take a corrective action when the measured distance is larger than a preprogrammed threshold distance.

15. The low-media alert system of claim 14, wherein the time-of-flight sensor is fitted to an aperture formed in a lid of the media container.

16. The low-media alert system of claim 14, wherein the time-of-flight sensor comprises an emitter adapted to emit at least one of a sound wave and a light wave, receive a reflection of the wave, and calculate a distance from the emitter to the reflective surface based on a time elapsed between the emitting and the receiving of the wave.

17. A method of providing a low-media alert for a water softener, the method comprising:
activating a sensor attached to a media container, the sensor sized and configured to provide water softening media to the water softener;
activating a controller to detect a level of the media in the container via the sensor; and
initiating a refilling protocol when a level of media in the container falls below a predetermined threshold.

18. The method of claim 17, wherein the step of attaching the sensor comprises retrofitting the sensor to a lid of an existing container.

19. The method of claim 17, further comprising using the media in the container to form a brine solution used for water softening.

20. The method of claim 17, wherein the step of initiating the refilling protocol comprises one of triggering an audio alert, triggering a visual alert, and displaying the media level on a display.
